(19) United States
(12) Patent Application Publication
(10) Pub. No.: US 2020/0240577 A1
(43) Pub. Date: Jul. 30, 2020

(54) SUPPORTING ROD AND BRACKET COMPRISING THE SAME

(71) Applicant: Shenzhen Youbaise Technology Co., Ltd., Shenzhen (CN)

(72) Inventor: DINGLAN LI, SHENZHEN (CN)

(73) Assignee: Shenzhen Youbaise Technology Co., Ltd.

(21) Appl. No.: 16/255,839

(22) Filed: Jan. 24, 2019

(51) Int. Cl. F16M 11/24; F16M 11/14; F16M 11/16; G03B 17/56

(52) U.S. Cl. CPC F16M 11/24; F16M 11/14; F16M 2200/022; G03B 17/561; F16M 11/16

(57) ABSTRACT

A supporting rod of a bracket includes: a first rod, having a first end connected to a connector and a second end provided with a first threaded member; at least one second rod, one end of each second rod being provided with a second threaded member, and the other end of each second rod being provided with a third threaded member, wherein the second threaded member on one of the at least one second rod is connected to the first threaded member on the first rod, or connected to another one of the at least one second rod; a third rod, having a third end provided with a fourth threaded member and a fourth end configured as a supporting portion; wherein the fourth threaded member is connected to the first threaded member, or connected to the third threaded member on one of the at least one second rod.

### TECHNICAL FIELD

The described embodiments relate to photographic devices, and in particular to a supporting rod of a bracket, and a bracket comprising the supporting rod.

### BACKGROUND

In general, during photographing, it is necessary to use a bracket to support a camera. In the related art, the bracket may include a supporting rod, and a length of the supporting rod is adjusted by using a telescopic rod, in order to achieve a height adjustment of the bracket. However, the telescopic rod may be slidable, such that the photography may be affected.

### SUMMARY

The present disclosure provides a supporting rod of a bracket, and the length of the supporting rod can be more stably changed.

The technical solution of the present disclosure may include the following.

In one aspect, a supporting rod of a bracket is provided. The supporting rod comprises: a first rod, having a first end configured to be connected to a connector of the bracket and a second end opposite to the first end and provided with a first threaded member, at least one second rod, one end of each second rod being provided with a second threaded member corresponding to the first threaded member, and the other end of each second rod being provided with a third threaded member, wherein the second threaded member on one of the at least one second rod is connected to the first threaded member on the first rod, or connected to the third threaded member on another one of the at least one second rod; a third rod, having a third end provided with a fourth threaded member and a fourth end opposite to the third end and configured as a supporting portion; wherein the fourth threaded member on the third rod is connected to the first threaded member on the first rod, or connected to the third threaded member on one of the at least one second rod.

In another aspect, a bracket is provided. The bracket comprises: a connector, configured to be connected to a photographic device; and a supporting rod, comprising: a first rod, having a first end configured to be connected to a connector of the bracket and a second end opposite to the first end and provided with a first threaded member, at least one second rod, one end of each second rod being provided with a second threaded member corresponding to the first threaded member, and the other end of each second rod being provided with a third threaded member, wherein the second threaded member on one of the at least one second rod is connected to the first threaded member on the first rod, or connected to the third threaded member on another one of the at least one second rod; a third rod, having a third end provided with a fourth threaded member and a fourth end opposite to the third end and configured as a supporting portion; wherein the fourth threaded member on the third rod is connected to the first threaded member on the first rod, or connected to the third threaded member on one of the at least one second rod.

In the present disclosure, by using a plurality of rods to form the supporting rod, when it needs to adjust the length of the supporting rod, it is possible to select a specific number of the second rods and successively connect to one another by threaded connection; or it is also possible to directly connect the first rod to the third rod by threaded connected without the second rod. Therefore, it is possible to more stably change the length of the supporting rod.

### BRIEF DESCRIPTION OF THE DRAWINGS

FIG. 1 is a schematic structural view of a bracket according to an embodiment of the present invention.

FIG. 2 is a schematic structural view of a supporting rod.

FIG. 3 is a disassembled perspective view of the supporting rod.

FIG. 4 is a cross-sectional view of a first rod.

FIG. 5 is a cross-sectional view of a second rod.

FIG. 6 is a cross-sectional view of a third rod.

FIG. 7 is an exploded view of a connector.

FIG. 8 is a cross-sectional view of the connector.

FIG. 9 is a partially enlarged view of the connector shown in FIG. 8.

### DETAILED DESCRIPTION

Technical solutions in embodiments of the present disclosure are clearly and completely described in the following with reference to the accompanying drawings in the embodiments of the present disclosure. Apparently, the described embodiments are only some of the embodiments of the present disclosure, but not all embodiments.

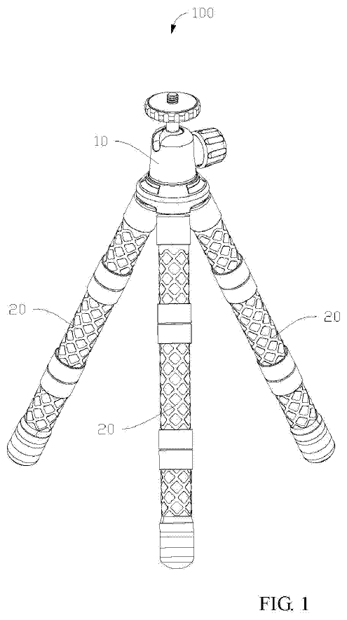

Referring to FIG. 1, a bracket 100 may be provided in the present disclosure. The bracket 100 may include a connector 10 and three supporting rods 20 coupled to the connector 10. The connector 10 may be configured to be connected to a photographic device such as a video camera, a mobile phone, or the like.

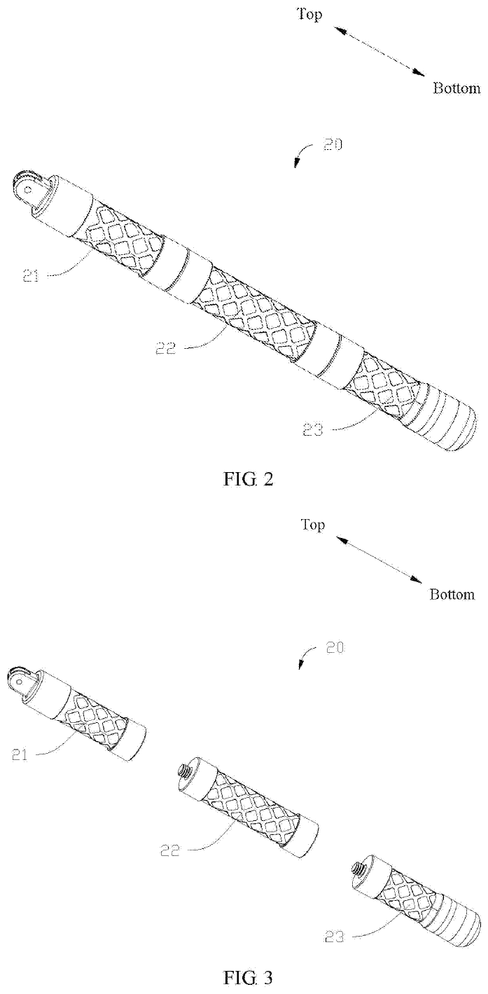

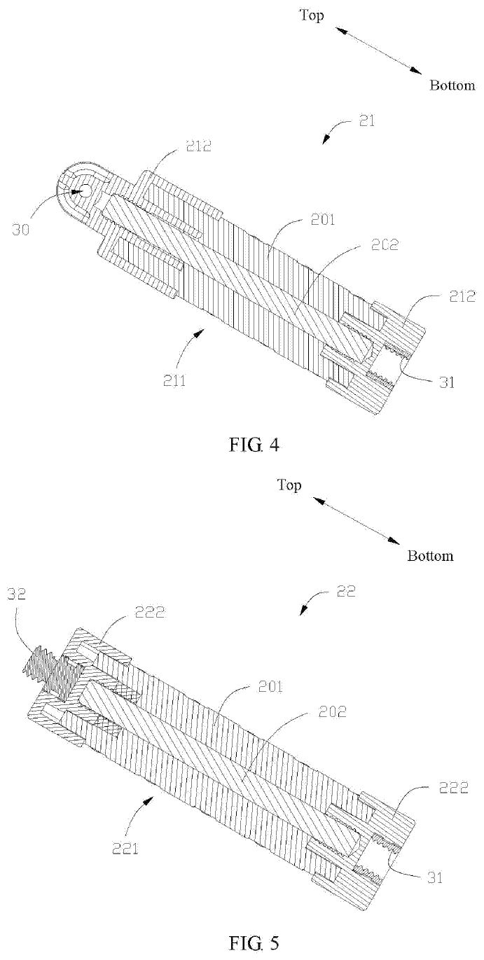

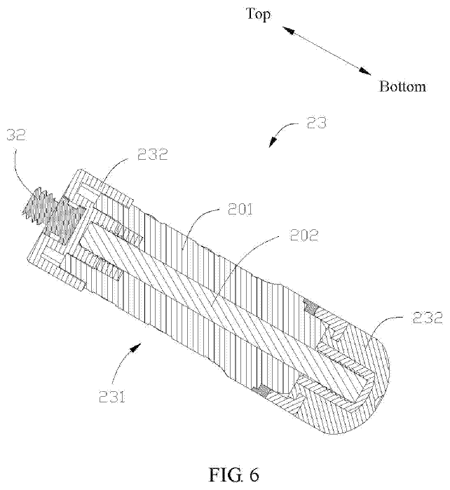

Referring to FIGS. 2 and 3, the supporting rod 20 may serve as a leg of the bracket 100, and may include a first rod 21, a second rod 22, and a third rod 23. Referring to FIG. 4, a first end of the first rod 21 may define a fixing hole 30, and be connected to the connector 10. A first threaded member 31 may be arranged at a second end of the first rod 21. In this embodiment, the first end may be the top end shown in FIG. 4, and the second end may be opposite to the first end and may be the bottom end in this embodiment. Referring to FIG. 5, at least one second rod 22 may be provided in some embodiments. A second threaded member 32 corresponding to the first threaded member 31 may be arranged at one end of the second rod 22 that is close to the second end of the first rod 21. A third threaded member 33 may also be arranged at the other end of the second rod 22. Referring to FIG. 6, a fourth threaded member 34 may be arranged at a third end of the third rod 23 that is close to the second rod 22, and a fourth end of the third rod 23 that is opposite to the third end may serve as a supporting portion. In some embodiments, the first threaded member 31 and the third threaded member 33 each may be a nut, while the second threaded member 32 and the fourth threaded member 34 each may be a bolt.

In some embodiments, one or more second rods 22 may be selected as required. When using one second rod 22, one end (the top end as shown in FIG. 5) of the second rod 22 may be connected to the first rod 21, and the other end (the bottom end) of the second rod 22 may be connected to the third rod 23. When using a plurality of second rods 22, the plurality of second rods 22 may be successively connected to one another to form an intermediate rod. In this case, the top end of the intermediate rod may be connected to the first rod 21, and the bottom end of the intermediate rod may be connected to the third rod 23.

It should be understood that, the third rod 23 may be directly connected to the first rod 21 without using the second rod 22.

Referring to FIG. 4, the first rod 21 may include a first rod body 211 and a pair of first end pieces 212. The pair of first end pieces 212 may be respectively fixed at two opposite ends of the first rod body 211 along the top-bottom direction. The first threaded member 31 may be disposed on one of the pair of first end pieces 212 (that is, the first end piece 212 at the bottom end), while the other of the pair of first end pieces 212 (the first end piece 212 at the top end) may define the fixing hole 30. A fixing member may pass through the fixing hole 30 and be further connected to the connector 10. In this way, the first rod 21 may be fixed to the connector 10.

Referring to FIG. 5, the second rod 22 may include a second rod body 221 and a pair of second end pieces 222. The pair of second end pieces 222 may be respectively fixed at two opposite ends of the second rod body 221. The second threaded member 32 may be disposed on one of the pair of second end pieces 222 (that is, the second end piece 222 at the top end), while the first threaded member 31 may be disposed on the other of the pair of second end pieces 222 (that is, the second end piece 222 at the bottom end).

Referring to FIG. 6, the third rod 23 may include a third rod body 231 and a pair of third end pieces 232. The pair of third end pieces 232 may be respectively fixed at two opposite ends of the third rod body 231. The second threaded member 32 may be disposed on one of the pair of third end pieces 232 (that is, the third end piece 232 at the top end), and the other of the pair of third end pieces 232 (that is, the third end piece 232 at the bottom end) may serve as a supporting portion.

The first rod body 211, the second rod body 221, and the third rod body 231 may each include an outer sleeve 201 and an inner core 202. The inner core 202 may be fixed in the outer sleeve 201, and two ends of the inner core 202 may be respectively connected to the corresponding end pieces. Optionally, a bottom end of the inner core 202 of the third rod body 23 may be coupled to the third end piece 232 by threaded connection. In this embodiment, the first rod body 211, the second rod body 221, and the third rod body 231 may each be bendable, such that the bracket 100 may be adapted to different environments. In this way, it is possible for the bracket 100 to better cooperate with the photographic device for photography.

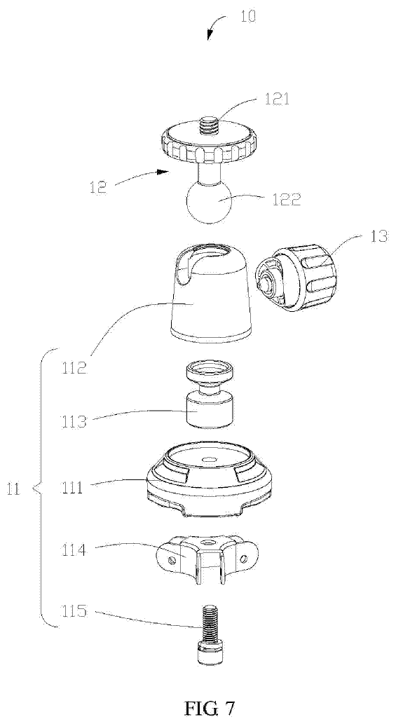

Referring to FIG. 7, the connector 10 may include a base 11, a rotatable member 12, and a locking screw 13. The rotatable member 12 may have a connecting screw 121 configured to be connected to the photographic device. The rotatable member 12 may further have a ball portion 122. The base 11 may include a bottom shell 111, an outer shell 112, a fixing member 113, a connecting piece 114, and a fixing screw 115.

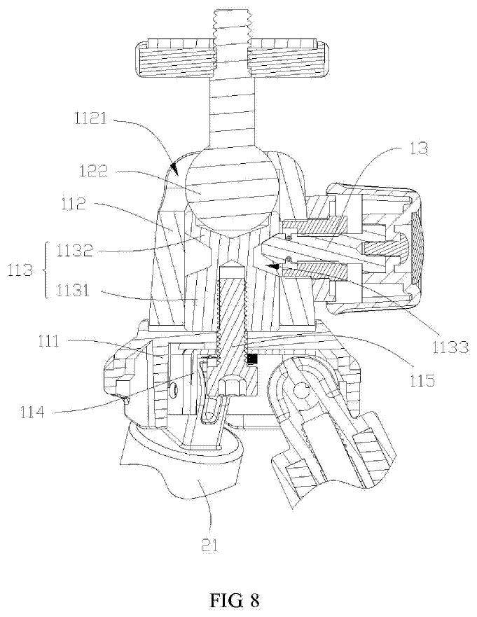

Referring to FIG. 8, the bottom shell 111 may support the outer shell 112. The fixing member 113 may be disposed in the outer shell 112. The fixing member 113 may include a fixing portion 1131 and a supporting portion 1132. A groove 1133 may be defined between the fixing portion 1131 and the supporting portion 1132. The connecting piece 114 may be disposed in the bottom shell 111 and connected to the first rod 21. The fixing screw 115 may successively pass through the connecting piece 114 and the bottom shell 111 from the bottom end, and be further connected to the fixing portion 1131, such that the fixing portion 1131 may be relatively fixed to the outer shell 112. A top end of the supporting portion 1132 may be in contact with the ball portion 122. The locking screw 13 may be fixed to a side of the outer shell 112. When screwing the locking screw 13, one end of the locking screw 13 may be received in the groove 1133 and further press the supporting portion 1132. In this way, the fixing member 113 may frictionally lock the ball portion 122, thereby locking an angle of the rotatable member 12.

One side of the outer shell 112 may define a notch 1211. When rotating the rotatable member 12, the rotatable member 12 may be received in the notch 1121, such that the rotatable member 12 may be rotated to a larger angle. In this way, it is possible for the bracket 100 to better cooperate with the photography device for photography.

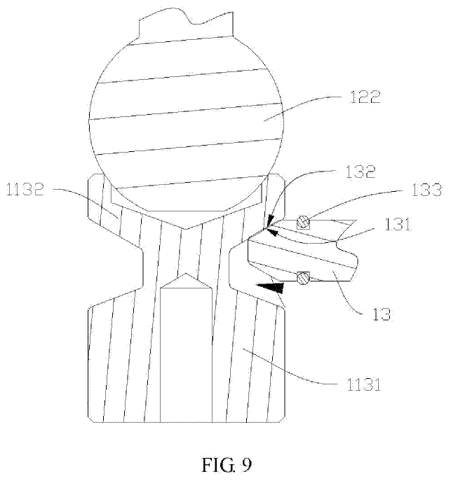

More specifically, referring to FIG. 9, the end of the locking screw 13 may have an inclined surface 131, and an inclined surface 132 may be defined in the groove 1133. The inclined surface 132 may correspond to the inclined surface 131 of the locking screw 13. When the inclined surface 131 at the inner end of the locking screw 13 is pressed to get into contact with the inclined surface 132 of the groove 1133, the supporting portion 1132 may be deformed to change the contact pressure between the supporting portion 1131 and the ball portion 122, thereby changing the frictional force between the supporting portion 1131 and the ball portion 122. In this way, it is easier to achieve the locking of the angle of the rotatable member 12.

Optionally, a stopping portion 133 may be disposed near the inner end of the locking screw 13. The stopping portion 133 may be configured to prevent the locking screw 13 from being detached from the outer shell 112.

The above embodiments are only some embodiments of the present disclosure, and are not intended to limit the present disclosure. Any modifications, equivalents, and improvements made within the spirit and principles of the present disclosure should be included in the protection of the present disclosure.

1. A supporting rod of a bracket, comprising:
a first rod, having a first end configured to be connected to a connector of the bracket and a second end opposite to the first end and provided with a first threaded member;
at least one second rod, one end of each second rod being provided with a second threaded member corresponding to the first threaded member, and the other end of each second rod being provided with a third threaded member; wherein the second threaded member on one of the at least one second rod is connected to the first threaded member on the first rod, or connected to the third threaded member on another one of the at least one second rod;
a third rod, having a third end provided with a fourth threaded member and a fourth end opposite to the third end and configured as a supporting portion; wherein the fourth threaded member on the third rod is connected to the first threaded member on the first rod, or connected to the third threaded member on one of the at least one second rod, wherein the third rod comprises:
a third rod body, and
a pair of third end pieces, fixed at two opposite ends of the third rod body;
wherein the fourth threaded member is disposed on one of the pair of third end pieces, and the other of the pair of third end pieces is configured as the supporting portion, the third rod body comprises a third outer sleeve and a third inner core; the third inner core is fixed in the third outer sleeve, and two ends of the third inner core are respectively connected to the pair of third end pieces, the third rod body is bendable, and a bottom end of the third inner core is coupled to the third end piece by threaded connection.

2. The supporting rod of claim 1, wherein the first threaded member and the third threaded member each is a nut, and the second threaded member and the fourth threaded member each is a bolt.

3. The supporting rod of claim 1, wherein the first rod comprises:
a first rod body, and
a pair of first end pieces, fixed at two opposite ends of the first rod body;
wherein one of the pair of first end pieces is connected to the connector, and the other of the pair of first end pieces is provided with the first threaded member.

4. The supporting rod of claim 3, wherein the first rod body comprises a first outer sleeve and a first inner core; the first inner core is fixed in the first outer sleeve, and two ends of the first inner core are respectively connected to the pair of first end pieces.

5. The supporting rod of claim 3, wherein the first rod body is bendable.

6. The supporting rod of claim 1, wherein the second rod comprises:
a second rod body, and
a pair of second end pieces, fixed at two opposite ends of the second rod body; wherein the second threaded member is disposed on one of the pair of second end pieces, and the third threaded member is disposed on the other of the pair of second end pieces.

7. The supporting rod of claim 6, wherein the second rod body comprises a second outer sleeve and a second inner core; the second inner core is fixed in the outer sleeve, and two ends of the second inner core are respectively connected to the pair of second end pieces.

8. The supporting rod of claim 6, wherein the second rod body is bendable.

9. (canceled)

10. (canceled)

11. (canceled)

12. (canceled)

13. A bracket, comprising:
a connector, configured to be connected to a photographic device; and
a supporting rod, comprising:
a first rod, having a first end configured to be connected to the connector of the bracket and a second end opposite to the first end and provided with a first threaded member;
at least one second rod, one end of each second rod being provided with a second threaded member corresponding to the first threaded member, and the other end of each second rod being provided with a third threaded member; wherein the second threaded member on one of the at least one second rod is connected to the first threaded member on the first rod, or connected to the third threaded member on another one of the at least one second rod;
a third rod, having a third end provided with a fourth threaded member and a fourth end opposite to the third end and configured as a supporting portion; wherein the fourth threaded member on the third rod is connected to the first threaded member on the first rod, or connected to the third threaded member on one of the at least one second rod, wherein the third rod comprises:
a third rod body, and
a pair of third end pieces, fixed at two opposite ends of the third rod body:
wherein the fourth threaded member is disposed on one of the pair of third end pieces, and the other of the pair of third end pieces is configured as the supporting portion, the third rod body comprises a third outer sleeve and a third inner core; the third inner core is fixed in the third outer sleeve, and two ends of the third inner core are respectively connected to the pair of third end pieces, the third rod body is bendable, and a bottom end of the third inner core is coupled to the third end piece by threaded connection.

14. The bracket of claim 13, wherein the first threaded member and the third threaded member each is a nut, and the second threaded member and the fourth threaded member each is a bolt.

15. The bracket of claim 13, wherein
the first rod comprises:
a first rod body, and
a pair of first end pieces, fixed at two opposite ends of the first rod body;
wherein one of the pair of first end pieces is connected to the connector, and the other of the pair of first end pieces is provided with the first threaded member;
the second rod comprises:
a second rod body, and
a pair of second end pieces, fixed at two opposite ends of the second rod body; wherein the second threaded member is disposed on one of the pair of second end pieces, and the third threaded member is disposed on the other of the pair of second end pieces.

16. The bracket of claim 15, wherein the first rod body comprises a first outer sleeve and a first inner core; the first inner core is fixed in the first outer sleeve, and two ends of the first inner core are respectively connected to the pair of first end pieces; the second rod body comprises a second outer sleeve and a second inner core; the second inner core is fixed in the outer sleeve, and two ends of the second inner core are respectively connected to the pair of second end pieces.

17. (canceled)

18. The bracket of claim 13, wherein the connector comprises a base and a rotatable member; the rotatable member has a ball portion disposed in the base; a locking screw is connected to a side of the base, such that an angle of the rotatable member is locked by the locking screw.

19. The bracket of claim 18, wherein the base comprises an outer shell and a fixing member disposed in the outer shell; the fixing member comprises a fixing portion and a supporting portion; a groove is defined between the fixing portion and the supporting portion; the fixing portion is fixed in the outer shell, one end of the supporting portion is in contact with the ball portion; the locking screw is capable of being received in the groove and pressing the supporting portion, such that the supporting portion frictionally locks the angle of the rotatable member.

20. The bracket of claim 19, wherein a notch is defined in the outer shell and the rotatable member is received in the notch; the locking screw has a first inclined surface, while a second inclined surface corresponding to the first inclined surface is defined in the groove.
